(19) United States
(12) Patent Application Publication
(10) Pub. No.: US 2006/0029249 A1
(43) Pub. Date: Feb. 9, 2006

(54) Loudspeaker with hair leather diaphragm

(75) Inventors: J. Dwidjaja Setiabudi, Kudus (ID); Adisusanto, Kudus (ID); Setiawan Yusran, Kudus (ID); Hadi Prayitno, Kudus (ID); Anang Kartika, Kudus (ID); Bandi Sumardi, Kudus (ID)

Correspondence Address: ROTHWELL, FIGG, ERNST & MANBECK, P.C., 1425 K STREET, N.W., SUITE 800, WASHINGTON, DC, 20005, US

(73) Assignee: PT. Hartono Istana Teknologi, Kudus (ID)

(21) Appl. No.: 10/911,534

(22) Filed: Aug. 5, 2004

(51) Int. Cl. H04R 1/02; H04R 1/00; H04R 1/20

(52) U.S. Cl. 381/426; 381/423; 381/432

(57) ABSTRACT

A hair leather diaphragm for a loudspeaker. The acoustic impedance of the hair leather diaphragm is lower than several existing loudspeaker diaphragms and closer to the acoustic impedance of air. As a result, there is improved energy transfer from the loudspeaker to yield higher sound pressure level (SPL). The hair leather diaphragm is tough which prevents deformation caused by mechanical pressure and is thus not easily torn.

### FIELD OF THE INVENTION

The present invention relates to a loudspeaker system and, more particularly, to a loudspeaker diaphragm material which provides enhanced energy transfer, higher sound pressure level as well as an attractive appearance.

### BACKGROUND OF THE INVENTION

Previous developments in material for use as a loudspeaker driver include materials such as magnetic material, voice coil material, frame material, diaphragm or cone material. Paper or carton material have been used for making the cone, as well as other materials such as polypropylene, honey comb, polyester fiber, glass fiber, aluminum, magnesium and titanium.

Alloy diaphragm material like aluminum, magnesium and titanium are stiff and provide good heat conduction from the voice coil. However, the diaphragms are easily deformed by mechanical pressure and are difficult to reform.

It is well documented that leather is used for musical instrument diaphragms, such as large and small drums, tambourines etc. that produce good natural sound.

In electrical engineering it is known that energy transfer from a source is maximized if the source impedance and load impedance are close in value or matched. Similarly in acoustics, diaphragm impedance which is closer to the impedance of air will result in greater energy transfer. Conventional diaphragm materials such as paper, carton, polypropylene, glass fiber, etc., each have a higher acoustic impedance than leather having a hair surface.

### SUMMARY OF THE INVENTION

One object of the present invention is to provide an acoustically improved loudspeaker diaphragm with an improved impedance match to air.

A further object of one embodiment of the present invention is to provide a loudspeaker cone body comprising leather material.

Subsequent to taking measurements using a standard impedance tube, it was found that the leather diaphragm bearing the hair surface presented a lower acoustic impedance relative to conventional diaphragms. As such, the impedance, therefore had a closer value to that of the impedance of air compared to other known diaphragms. This has ramifications in terms of improving the energy transfer which results in a higher sound pressure level.

A further object of one embodiment of the present invention is to provide a loudspeaker comprising:
a conical body composed of treated leather;
a support frame;
a voice coil;
a plurality of magnets; and
connection means for connecting the driver to a signal source.

The conical body can be formed by known techniques in the art. As a possibility, the existing paper speaker cones can be improved by applying a layer of treated leather thereto with the remaining components of a loudspeaker driver being well known in the art.

It is known that leather is extremely tough and for this reason it is therefore not easily deformed or torn by (with??) significant mechanical forces that typically occur when a loudspeaker driver is exposed to mishandling or strong signals.

As a further advantage, by incorporating the hair surface, it is believed that the sound energy is more evenly dissipated from the driver to produce the results of increased sound pressure level.

A further object of one embodiment of the present invention is a loudspeaker, comprising:
housing for housing the loudspeaker;
a conical body composed of treated leather;
a support frame;
a voice coil;
a plurality of magnets; and
connection means for connecting the driver to a signal source.

Yet another object of one embodiment of the present invention is to provide a method of increasing the sound pressure level of a loudspeaker at a selected frequency, comprising:
providing a loudspeaker having a conical body, the body comprising leather material; and
passing a signal through the loudspeaker, whereby the signal is processed to produce a higher sound pressure level relative to a non leather body.

### BRIEF DESCRIPTION OF THE DRAWINGS

Having thus generally described the invention, reference will now be made to the accompanying drawings:

FIG. 1 is a cut away of one embodiment of the loudspeaker;

FIG. 2 is a further embodiment of the loudspeaker according to the present invention;

FIG. 3 is a cut away of yet another embodiment of the loudspeaker according to the present invention;

FIG. 4 is a schematic illustration of a conventional loudspeaker with the drivers positioned in situ;

FIG. 5 is a schematic illustration of the apparatus used to measure the diaphragm acoustic impedance; and

FIG. 6 is a graphical representation of the frequency response curves comparing a hair leather diaphragm relative to a polypropylene diaphragm.

### DETAILED DESCRIPTION OF THE PREFERRED EMBODIMENTS

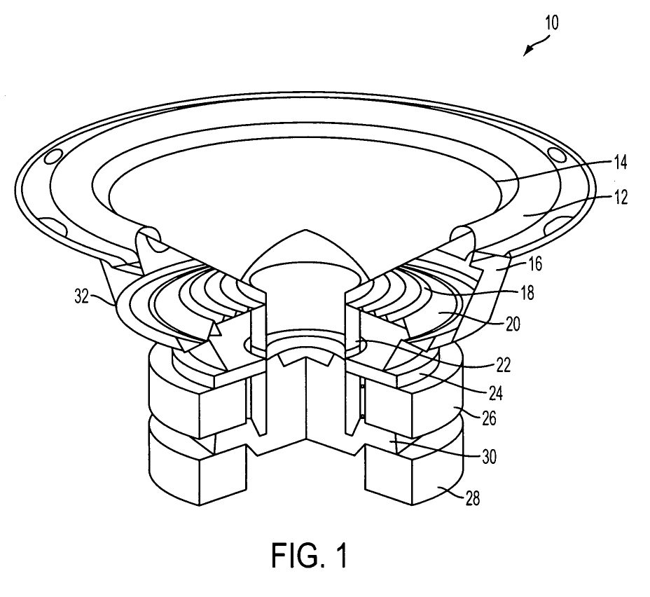

Referring now to FIG. 1, numeral 10 denotes the overall loudspeaker driver which, as is known, includes an arcuate skirt 12 for permitting movement of the cone 14. The skirt 12 is typically formed of a suitable polymer or may comprise rubber or paper. These materials are well documented for use in loudspeaker manufacturing.

The diaphragm or cone 14 and skirt 12 are affixed to frame 16 having in general a frustoconical or basket type shape. The frame also supports the paper cone 18, damper 20 and the voice coil 22. Adjacent the frame 16 is a washer 24 together with a first magnet 26 separated from a second magnet 28 by a yoke 30. Terminals 32 allow for connection of the driver 10 to a signal source (not shown). In this embodiment, the diaphragm or loudspeaker cone 14 is composed of treated leather material, which has good durability and produces natural sound. As has been stated herein previously, treated leather is extremely tough and for this reason it is therefore not easily deformed or torn with significant mechanical forces that typically occur when a loudspeaker driver is exposed to mishandling or strong signals. As is known, the “woofing” action results in physical movement of the cone body which, over repeated use or sudden bursts of low frequency sound, can result in diaphragm fracture or other structural compromise. By incorporating the leather material, this difficulty is obviated.

As has been stated herein previously, a rigid and stiff diaphragm that can effectively move like a piston without producing higher order modes is essential. As is known, higher order modes will result in undesirable harmonic frequencies which, of course, lead to degraded sound quality. By making the provision of a treated leather diaphragm, the result is a stiffer diaphragm than that which is found with the relatively soft polypropylene type diaphragms.

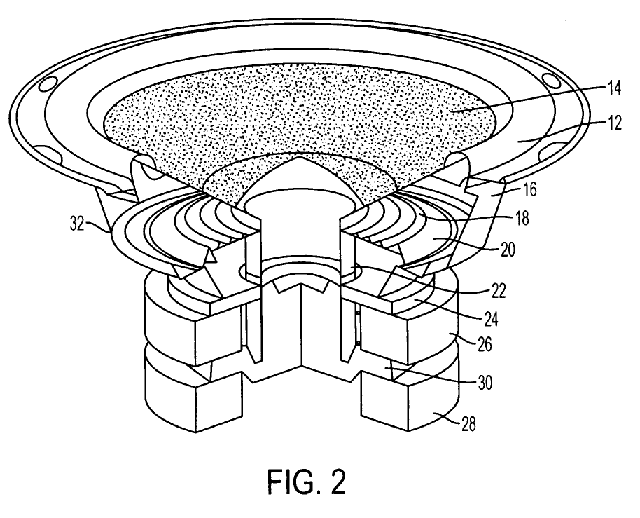

FIG. 2 illustrates a second embodiment of the invention where the treated leather material 14 includes a hair surface indicated in the drawing by the lines of demarcation, which has been found to produce improved electro acoustic properties relative to conventional materials used in loudspeaker engineering. As an example, the treated leather diaphragm produced much higher sound pressure levels relative to conventional polypropylene typically used in driver manufacturing. Significant results relative to conventional polypropylene diaphragms have been documented and will be set forth hereinafter.

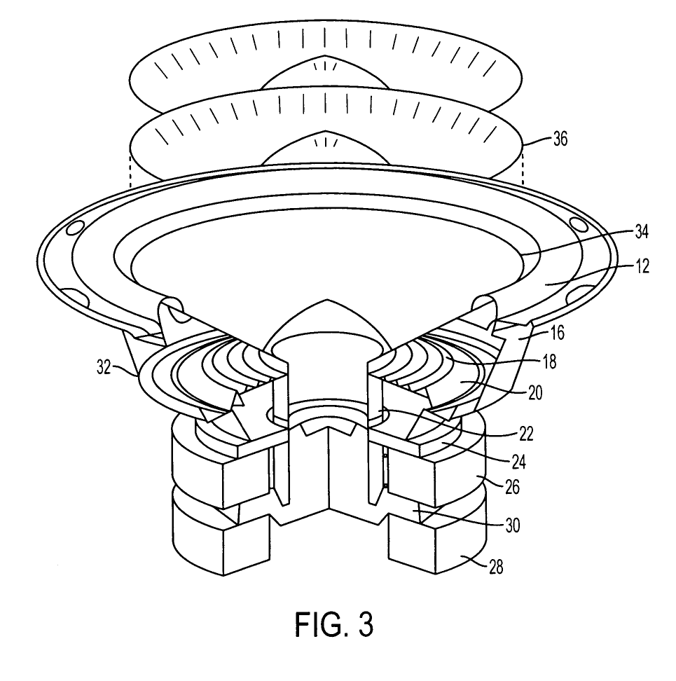

In respect of FIG. 3, shown is a further embodiment of the present invention in partially exploded and cut away form where diaphragm 14, referenced from FIGS. 1 and 2, is denoted by numeral 34 and comprises a conventional polypropylene material to which optionally may be attached a layer of treated leather bearing hair as denoted by numeral 36. As will be appreciated, the material for diaphragm 34 could easily be paper, fiberglass or a suitable metal material known for use in diaphragm manufacturing.

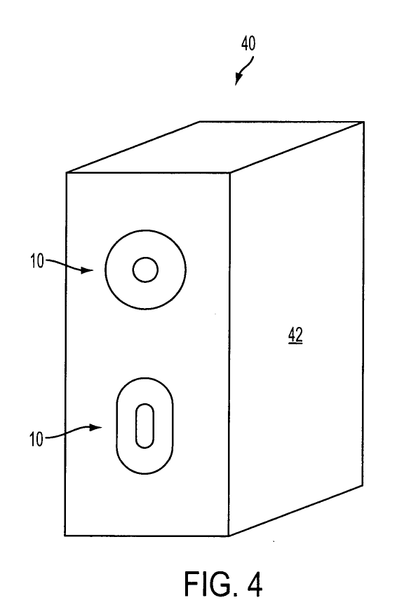

Referring now to FIG. 4, numeral 40 globally denotes a loudspeaker cabinet wherein the individual drivers 10 are mounted or housed within the cabinet 42 forming the loudspeaker. As illustrated in FIG. 4, the drivers 10 can take the form of either circular or non-circular shapes such as elliptical drivers or any other suitable shape. It is also to be noted that the driver may comprise the flat type drivers where the diaphragm 14 as referenced in FIGS. 1 and 2 can comprise a flat or planar body.

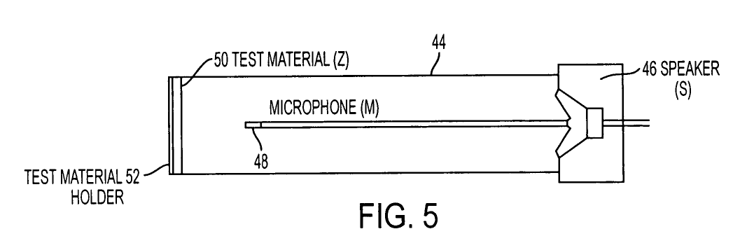

As is known by sound engineering personnel skilled in the art, every diaphragm material has an acoustic impedance value that can be measured using an impedance tube such as that shown in FIG. 5 and referenced by numeral 44. In use, a test signal is generated by the loudspeaker 46 with the sound waves (not shown) traveling down tube 44. A microphone 48 disposed within tube 44 measures the sound pressure along the tube 44. The diaphragm material to be measured is fitted at the end of the tube, the material being denoted by numeral 50 and held in place by a rigid holder 52. Acoustic impedance is known from the basic formula:

$$Z ( 0 ) = {Z}_{c} \{ \frac{2 ( p ) ( {p}^{2} - 1 ) sin 2 k ( {x}_{1} )}{( {p}^{2} + 1 ) + ( {p}^{2} - 1 ) cos 2 k ( {x}_{1} )} \} with k = \frac{2 π f}{c}$$

Z_{c}=acoustic impedance of air
c=speed of sound in air
f=frequency

$$p = \frac{{p}_{max}}{{p}_{min}} = \frac{( 1 + r )}{( 1 - r )}$$
pₘₐₓ=maximum pressure
pₘᵢₙ=minimum pressure
r=reflection coefficient
x₁=first node location of the standing wave

Based on the formula and the tests conducted in accordance with the present invention, it was found that the acoustic impedance for the treated leather diaphragm having the hair surface was lower than the acoustic impedance of other loudspeaker diaphragm materials. Accordingly, the hair bearing diaphragm acoustic impedance was found to be closer to the acoustic impedance of air relative to other materials. This electro acoustic feature means that the diaphragm according to the present invention is capable of transferring acoustic energy from the diaphragm to the air better than the other materials tested which, in turn produces a higher sound pressure level. In terms of the thickness of the treated leather and/or combination of hair and treated leather, this can be adjusted to reach the optimum acoustic impedance.

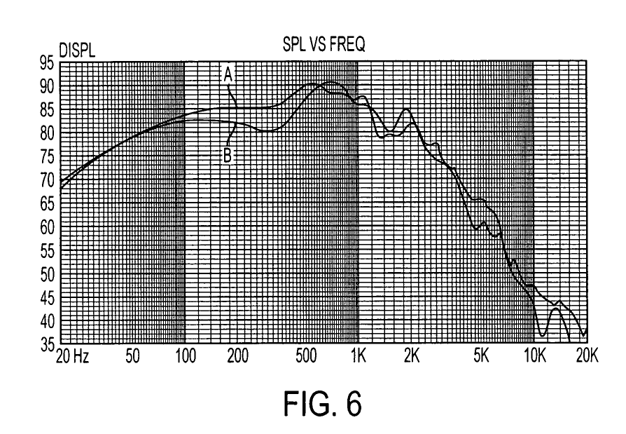

With reference to FIG. 6, there is illustrated graphically a series of frequency response curves that compare the sound pressure level of the hair treated leather diaphragm denoted by the data noted by A with a diaphragm composed of polypropylene, the data being denoted by B. At a frequency between 100 Hz and 1200 Hz the sound pressure was found higher between 1 to 5 decibels (dB) for the hair treated leather diaphragm.

Although embodiments of the invention have been described above, it is limited thereto and it will be apparent to those skilled in the art that numerous modifications form part of the present invention insofar as they do not depart from the spirit, nature and scope of the claimed and described invention.

We claim:

1. A loudspeaker cone body comprising leather material.

2. The body as set forth in claim 1, wherein said leather material includes a hair over the surface thereof.

3. The body as set forth in claim 1, wherein said body further includes a member selected from the group consisting of paper, polypropylene, honey comb, fiberglass, aluminum, magnesium and titanium, said member connected to said leather.

4. A loudspeaker driver, comprising:
a conical body composed of leather;
a support frame;
a voice coil;
a plurality of magnets; and
connection means for connecting said driver to a signal source.

5. The driver as set forth in claim 4, wherein said conical body includes a layer of hair.

6. The driver as set forth in claim 1, wherein said body further includes a member selected from the group consisting of paper, polypropylene, honey comb, fiberglass, aluminum, magnesium and titanium, said member connected to said leather

7. A loudspeaker driver, comprising:
a housing for housing said loudspeaker;
a conical body composed of leather;
a support frame;
a voice coil;
a plurality of magnets; and
connection means for connecting said driver to a signal source;

8. The loudspeaker as set forth in claim 7, wherein said leather material includes hair over the surface thereof.

9. The loudspeaker as set forth in claim 7, wherein said body further includes a member selected from the group consisting of paper, polypropylene, honey comb, fiberglass, aluminum, magnesium and titanium, said member connected to said leather

10. A method of increasing the sound pressure level of a loudspeaker at a selected frequency, comprising:
providing a loudspeaker having a conical body, said body comprising leather material; and
passing a signal through said loudspeaker, whereby said signal is processed at a higher sound pressure level relative to a non leather body.

11. The method as set forth in claim 10, further including the step of providing hair over the surface of said leather.
